(19) United States
(12) Patent Application Publication
(10) Pub. No.: US 2002/0198005 A1
(43) Pub. Date: Dec. 26, 2002

(54) Location and velocity related control system for wireless communication devices

(76) Inventors: Robert A. Hilton, Corvallis, OR (US); John T. McVickar, Eugene, OR (US)

Correspondence Address: Robert A. Hilton, 3475 N.W. Tanager Drive, Corvallis, OR, 97330, US

(21) Appl. No.: 10/136,737

(22) Filed: May 2, 2002

Related U.S. Application Data
(60) Provisional application No. 60/290,500, filed on May 11, 2001.

(51) Int. Cl. H04Q 7/20

(52) U.S. Cl. 455/456; 455/404

(57) ABSTRACT

A logic based control system to modify and improve operations of wireless communications devices and the operating systems of a plurality of portable wireless communications devices by continuously, selectively and automatically controlling, enabling and/or disabling access to the transmission and reception of portable wireless communication devices depending on the factors of velocity, location and/or time of said wireless communication device, while continually enabling access to emergency communications at any time, location and/or velocity.

### CROSS-REFERENCE TO RELATED APPLICATION

This application claims the benefit of U.S. Provisional Patent Application Serial No. 60/290500, filed May 11, 2001.

### FEDERALLY SPONSORED RESEARCH

Not Applicable

### SEQUENCE LISTING OR PROGRAM

Not Applicable

### BACKGROUND

1. Field of Invention

This invention relates generally to wireless communication devices, and specifically to a logic based control system, which improves public safety and decorum when operating portable and other wireless communication devices.

2. Description of Prior Art

The operation of portable, wireless communications devices can be distracting and more importantly, quite dangerous to both the users thereof and to others around them, when being operated in complex environments such as moving vehicles. Safety and security solutions for effectively controlling the use of portable, wireless communication devices are actively being sought by private and public entities.

Public entities are trying to control the use of portable, wireless communication devices, while the user is driving a motor vehicle, by the enactment and enforcement of legislative statutes. New York SB 5400 requires that no person operate a motor vehicle while using a hand-held mobile phone. Provides emergency exception. Provides minimum and maximum for first time and subsequent offenses. Provides that law enforcement may issue an appearance ticket with a verbal warning for a period of one month to educate the public on this new law and prohibits local governments from regulating the use of mobile telephones in motor vehicles. Enacted Jun. 28, 2001. Tennessee SB3, Permits computer or other electronic displays in utility motor vehicles to be used by utility employee only while vehicle is stopped, standing or parked. Identical to HB 126. Enacted Mar. 14, 2001. New Jersey AB3241 Introduced February 2001. Prohibits holder of a driver examination permit from using any interactive wireless device while operating a motor vehicle. Creates emergency exception's. Enacted Jan. 8, 2002. At present, there are 79 current or enacted state legislation bills (2001-2002) in 27 states regarding the regulation or banning of wireless devices while driving. Federal regulations now mandate the capability of including reliable real-time position data in cell phones that will meet the FCC requirement of electronic location of 911 calls from cell phones (E9-1-1). There is also pending federal legislation regarding the control of wireless devices. These laws are being proposed and passed in order to try to reduce the growing frequency and severity of automobile accidents where the concurrent use of a portable, wireless communication device is causative or contributory. These new laws are an effort to improve the public's safety.

However, the employment of laws to solve this problem successfully requires compliance with the terms of the applicable statutes, which is in reality, voluntary on the part of the vehicle operator. Otherwise, enforcement on the part of police is required; in which case, offending drivers must be both observed and caught, while driving and simultaneously operating the wireless communication device. One might expect voluntary obedience to such new laws to be similar to the present compliance with existing the laws governing highway speed limits for motor vehicles. Therefore, the intended, beneficial, preventative effects of such laws, enacted to control the use of portable, wireless communication devices, while driving, may be quite random and consequentially, rather ineffective as well as very expensive for governments to enforce. Furthermore, these new laws may not address the problem of the distraction to the driver's concentration caused by a passenger's use of a portable, wireless communication device while the vehicle is moving.

U.S. Pat. No. 6,353,778 to Brown (2002) discloses an automobile computer control system for limiting the usage of wireless telephones in moving automobiles comprising an implementation for sensing when the velocity of the automobile exceeds a predetermined velocity. This system uses an infrared device physically attached to the automobile for sensing when a wireless telephone is in use by the driver of the equipped automobile and a function responsive to the sensing device signal for limiting the use of a properly equipped wireless telephone by the driver of a properly equipped automobile when the velocity of that automobile exceeds said predetermined value.

This disclosure absolutely requires the described infrared velocity-sensing device, which is essentially an accessory, added and attached to the automobile. Therefore the velocity-sensing device may be easily removed or mechanically disabled. Control of the cell phone or wireless device is effective only in a very small area, the driver's seat of a properly equipped automobile. The infrared signal to the cell phone or wireless device can be easily purposely blocked, masked, interrupted or degraded. The effective control of this disclosure is over a wireless device located only in very a particular area and circumstance. It does not control the wireless device or cell phone itself, independent of the separate infrared, velocity-sensing device. This disclosure does not allow for any control of wireless devices in situations other than within a small area of an equipped automobile. There are a number of other situations or locations where the use of wireless communications devices may be unsafe, illegal or disruptive.

At present, the Federal Aviation regulations, Sec. 125.204, Subpart F, Sec. 135.144, Subpart C, Sec. 121.306, Subpart K, Sec. 91.21, Subpart A and the U.S. commercial airlines require that cellular telephones, computers, wireless communication devices and other electronic devices not be used in aircraft prior to, during and after takeoff and landings in order to protect the safe operation, navigation, communication and other systems necessary for safely operating an aircraft. For similar reasons, cellular telephone use is forbidden during the entire flight. Currently, passengers are asked and advised in print to turn of such devices before takeoff and landing. Again compliance is essentially voluntary.

Japanese Patent Laid-Open No. 10-224856 discloses an example of mobile communication terminal equipment designed to observe such etiquette. The mobile communication terminal is provided with a reception electric-field intensity detector and a fading pitch detection circuit that determines from the reception electric-field intensity whether a moving speed of the terminal exceeds a predetermined value or not. Then, a response controller determines whether the terminal is moving at high speed or not, based on a determination of the fading pitch detection circuit. When the determination of the response controller shows that the terminal is moving at high speed, the terminal automatically responds to an incoming call, sends a response message to the opposite party of the communication. And the terminal stores a message received from the opposite party in a memory.

This disclosure apparently does not prevent a party in a high speed, moving environment from calling out while moving. In the case of an automobile driver would be distracting and could be quite dangerous and in some states in this country is illegal. The discloser would offer no control the case of using a wireless communication device on a commercial aircraft. Apparently the concern in this disclosure is with etiquette more than safety. Although it appears that emergency calls could be made out, no incoming emergency messages would be immediately apparent to the wireless user. This disclosure apparently does not provide for the capability to control wireless communication devices in particular locations or venues other than ones moving at high speed.

There are many other environments, such as restaurants, theaters and confidential work sights where the distractions caused by the use and operation of portable, wireless communication devices, might be inappropriate and may disrupt presentations, performances or other primary activities being offered in such environments.

At the present, commonly, persons attending a theater or other performances and assemblies are simply asked verbally by the venue's personnel, to turn off their portable, wireless communication devices just prior to a performance beginning or upon entering the theater or assembly's premises. Once again, compliance in these environments is essentially only voluntary on the part of persons in possession of portable, wireless communication devices.

There are a variety means for sensing the velocity of movement of a wireless communication device. There are currently many portable, wireless communication devices, which use and incorporate Satellite Positioning System (SATPS), such as Global Positioning System (GPS) tracking systems. These devices include but are not limited to, cellular telephones which incorporate the use of GPS devices and systems as part of their operating systems and/or hardware, for determining, and tracking the physical location of that particular portable, wireless communication device. GPS and other specially equipped devices are capable of measuring and displaying the velocity at which that particular device is moving.

Japanese Patent Laid-Open No. 10-1 57555 discloses another example of an apparatus with a function of calculating moving speed. In the portable telephone apparatus disclosed therein, a radio section detects a time variation of electric field intensity of a radio signal received through an antenna. Then, a computation section calculates the moving speed of the portable telephone in the mobile unit based on this variation. And the computation section determines whether the portable telephone apparatus is being used in the running car or not, depending on this moving speed and regulates outgoing and incoming calls of the portable telephone apparatus based on the decision. Further, a location detection section detects the current location using radio waves from GPS (Global Positioning System) satellites. Then, the computation section calculates the moving speed of the own portable telephone apparatus in the mobile station based on this current location. And the computation section determines whether the portable telephone apparatus is being used in the running vehicle, based on this moving speed. Outgoing and incoming calls of the portable telephone apparatus are regulated based on the determination.

This disclosure apparently applies primarily to portable telephone apparatus. It apparently does not provide for uninterrupted emergency communications such as 911 calls, which as noted above is now required by a Federal regulation. This disclosure, once again, apparently does not provide for the capability to control wireless communication devices in particular locations or venues other than ones moving at speed. This disclosure also apparently does not provide for other override capabilities such as using a wireless communication device as a passenger while moving in a chauffeured vehicle, or on approved public transport.

Japanese Patent Laid-Open No. 10-108263 discloses prior art. In the radio communication apparatus disclosed therein, a received signal strength detector measures an RSSI value at predetermined intervals. The RSSI value takes a value corresponding to reception field intensity of a radio channel. The amount of variation of this RSSI is converted to the moving speed of the radio communication apparatus. And, whether the radio communication apparatus is traveling at low speed or at high speed is determined based on the moving speed. Outgoing and incoming calls of the radio communication apparatus are regulated based on the determination. And, therein, a method of reducing moving speed determination efforts is disclosed. In the method, the radio communication apparatus is accumulating the amount of variation of RSSI a predetermined number of times or during a predetermined period of time. And the radio communication apparatus converts the amount of the accumulation to a velocity value.

This disclosure again, apparently does not provide for uninterrupted emergency communications such as 911 calls, which as noted above is now required by a federal regulation. This disclosure apparently does not provide for the capability to control wireless communication devices in particular locations or venues other than ones moving at speed. This disclosure also apparently does not provide for other override capabilities such as using a wireless communication device as a passenger while moving in a chauffeured vehicle, or on approved public transport.

U.S. patent application #20010012781, Suzuki, Isao; (Tokyo, JP) file Feb. 5, 2001, discloses another method that is not dependent on GPS for determining easy and accurate estimation of the moving speed of a portable telephone.

Once again, this disclosure apparently applies primarily to portable telephone apparatus. It apparently does not provide for uninterrupted emergency communications such as 911 calls, which as noted above is now required by a federal regulation. This disclosure, once again, apparently does not provide for the capability to control wireless communication devices in particular locations or venues other than ones moving at speed. This disclosure also apparently does not provide for other override capabilities such as using a wireless communication device as a passenger while moving in a chauffeured vehicle, or on approved public transport.

### OBJECTS AND ADVANTAGES

Accordingly, several objects and advantages of this invention are:

1) To automatically exert control over operation of portable and other wireless communication devices, equipped with this control system, when those devices are located within a moving environment such as a moving automobile or moving aircraft. An advantage this invention (the control system) provides in such circumstances, is that it operates essentially automatically and does not require voluntary compliance of the device's user in order to be effective. The invention can improve public safety without requiring the apprehension or intersession by police or other authorities, in order to enforce laws governing the use of such wireless communication devices while driving a motor vehicle or aviation rules. This invention provides a solution, which enforces compliance that is not random in its enforcing effect and is comparatively quite inexpensive for governments or airline authorities to employ.

2) To provide the possibility of control over operation and use of portable and other wireless communication devices, equipped with this control system, when those devices are located within a an environment where the operation of such devices might be disruptive to other primary activities conducted in that environment, such as theaters, restaurants or confidential work sights. The invention enables the possibility for the managers of such venues to have the ability to block the use of wireless communication devices within such premises or venues without soliciting or requiring the voluntary compliance of the user of the wireless communication device. Such managers may have the advantage of automatically controlling the use of wireless communication devices within such venues, for prolonged or specific periods of time, independent of the device's users control. Thereby, the invention can improve appropriate public decorum in such situations.

3) To provide the possibility of being able to use portable and other wireless communication devices, equipped with this control system, in qualifying and properly equipped, moving public transit and certain, specific, qualifying and properly equipped moving vehicles or moving environments.

4) To enable access to emergency wireless communication at any time or place for wireless communication devices, equipped with this control system.

### SUMMERY

The invention, a logic based control system for a plurality of wireless communications devices to modify their operating systems by using velocity, location and/or time as factors to control access to the transmission and reception of wireless devices equipped with this control system.

### FLOW CHARTS

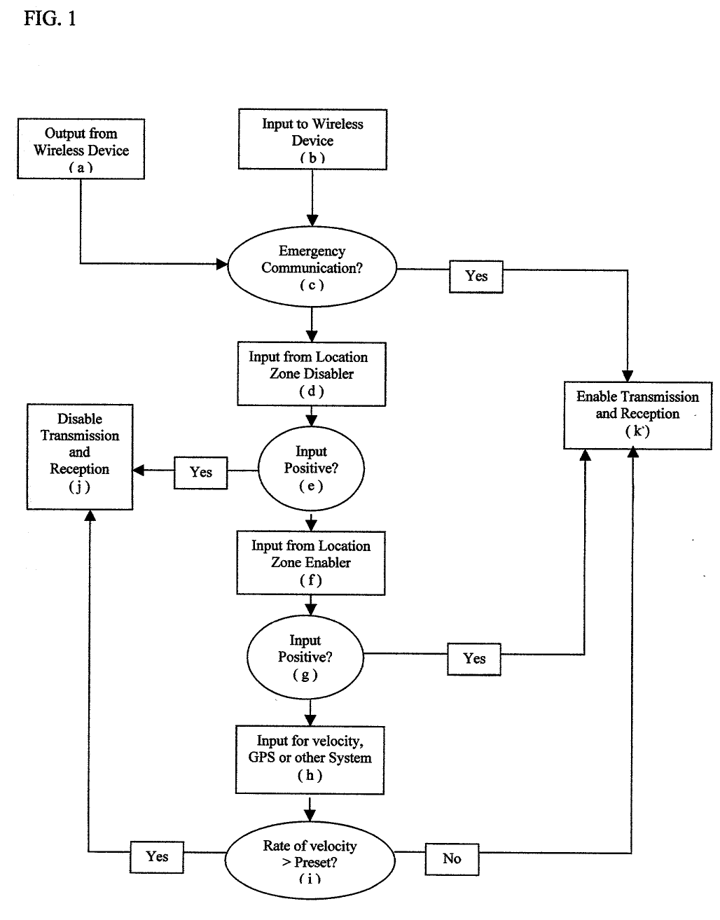

FIG. 1 on the following page, is a flow chart, showing the general operation of the invention, a logic based control system to be applied to wireless communications devices and the operating systems thereof.

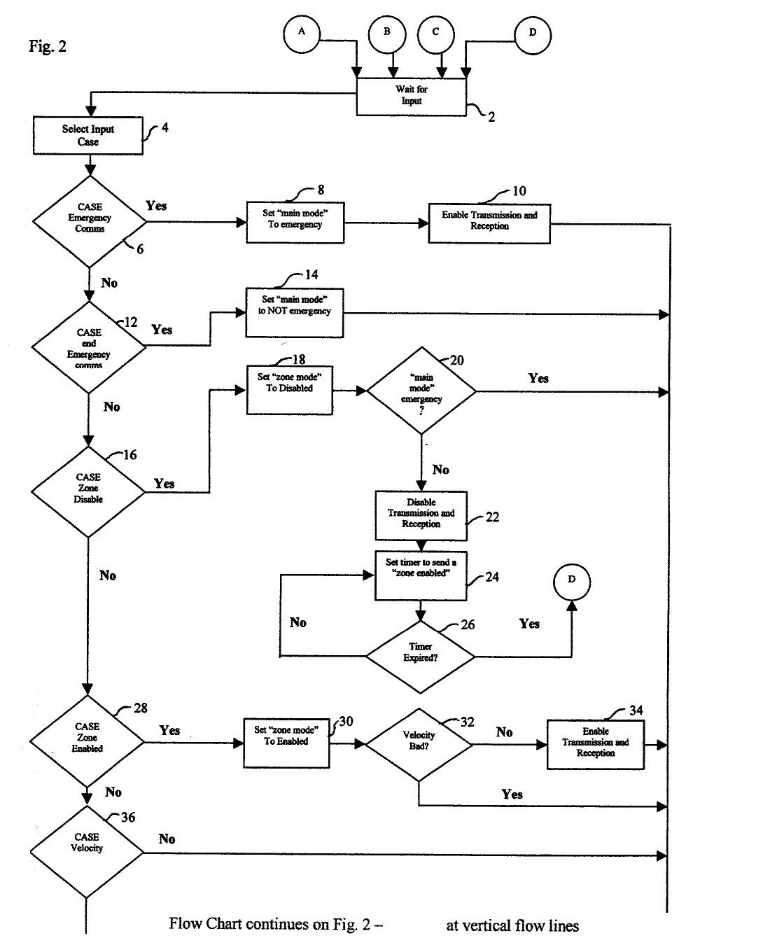

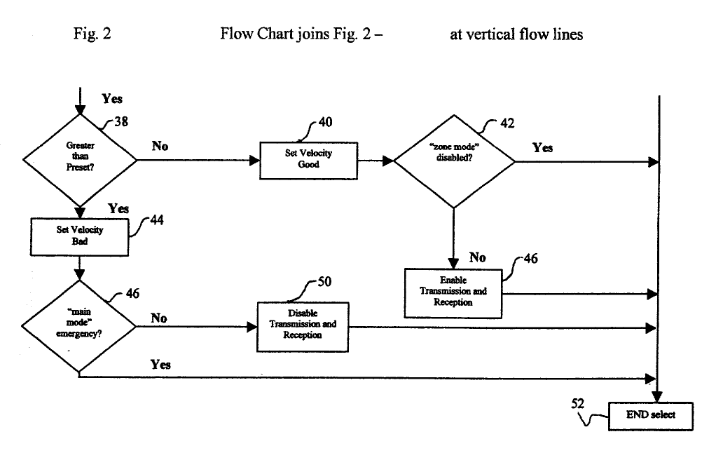

FIG. 2 (two pages) shows a detailed flow chart of the invention.

### DETAILED DESCRIPTION

The invention is a logic based control system configured to enable and disable access to the operation, reception and transmission of portable and other wireless communication devices given the presence of particular conditions and events which may include velocity, location and/or time. The “pseudo code” shown below represents a software embodiment of the invention. The Flow Charts, FIG. 1 and FIG.2 (two pages), are graphic representations of the invention, showing the logic of the control system and it's operation. The invention may be realized by means of software, PROM, E.P.R.O.M., integrated circuits, fixed circuitry, or hardware, solely or by any combinations thereof. The invention may be integrated into the operating systems of wireless communication devices remotely, or integrated into wireless communication devices themselves, in order to modify their operation to comply with the logical parameters of the invention.

### PREFERRED EMBODIMENT

A preferred embodiment is as software added to modify the operating systems of wireless communications devices. On the following page is the preferred embodiment expressed as software in “pseudo code”. The following “Pseudo code” is shown on a single page for the ease of the reader in understanding the code. “Pseudo code” is used here to represent a software embodiment of the invention in the generic sense.

Wait For Input

| DO CASE: | |
|---|---|
| CASE | emergency communications input |
| | set MAIN_MODE to “emergency” |
| | enable T & R |
| CASE | end emergency communications input |
| | set ZONE_MODE to “not emergency” |
| CASE | zone disabled input |

set ZONE_MODE to “disabled”
IF MAIN_MODE “ = not emergency”

disable T & R
set timer to send enable message to input
IF timer expired

send zone enabled message
ENDIF

ENDIF

| | |
|---|---|
| CASE | zone enabled input |

set ZONE_MODE to “enabled”
IF VELOCITY = “ok”

enable T & R

| | ENDIF |
|---|---|
| CASE | velocity input |

IF (velocity >preset)

set Velocity = “not ok”
IF MAIN_MODE + “not emergency”

disable T & R

ENDIF

ELSE

set velocity to “ok”
IF ZONE_MODE = “enabled”

enable T & R

ENDIF

ENDIF

END CASE:

### OPERATION OF INVENTION

The flow chart, FIG. 1, shows the general operation of the invention. The output from Wireless Device (a) and Input to Wireless Device (b) of a wireless communication device are controlled by conditions or events relative to desired outcome behavior. The control system continuously checks input and output conditions to and from the wireless communication device. If an emergency communication (c) condition arises (yes), then the controller system automatically overrides to Enable Transmission and Reception (k) mode. Under normal operating circumstances, when no emergency communication condition exists, the control system routes to and checks input from Location Zone Disabler (d). If input from Location Zone Disabler (d) is positive (yes), then the control system routes to Disable Transmission and Reception (j) mode. When the Location Zone Disabler condition is not positive, the control system continues to route to and check input from Location Zone Enabler (f). If input is positive (yes), then the control system routes to Enable Transmission and Reception (k) mode. If input is not positive, then the control system continues routing to check input from velocity, GPS or other System (h). If Rate of velocity>Preset? (i) input is greater than preset conditions or events (yes), the control system routes to Disable Transmission and Reception (j) mode. When Rate of velocity>Preset? (i) input is less than preset conditions (no), the control system routes to Enable Transmission and Reception (k) mode.

The Flow Chart, FIG. 2, (two pages) is a more detailed flow chart representation of the invention. FIG. 2 shows the operation of said control system under certain conditions or events. The control system continuously waits and checks for equipped wireless communication device's input and output, along with their conditions or events (2). The control system uses this input and output, along with their conditions or events as control system input. This includes, but is not limited to the following: (A) Reception input, including, but not limited to, incoming communications, incoming emergency communications, zone disable communications and zone enable communications. (B) Transmission output, including, but not limited to, outgoing communications, velocity reporting communications and outgoing emergency communications. (C) Reception of velocity input, including, but not limited to GPS signal communications, cellular tower signal communications and velocity information communications. (D) Internally generated input, including, but not limited to, timer status and control system status.

From Wait for Input (2) mode, control system input routes to Select Input Case (4) mode, then first to CASE Emergency Comms (6) condition. If yes, then input routes to set “main mode” To emergency mode (8) mode and on to Enable Transmission and Reception (10) mode. If no, then input routes to CASE end Emergency (12) condition. If yes, then input routes to Set “main mode” to NOT emergency (14) mode. If no, then input routes to CASE Zone Disable (16) condition. If yes, then input routes to Set “zone mode” To Disabled (18) and then to “main mode” emergency? (20) condition. If no, then input is routed to Disable Transmission and Reception (22) mode, on to Set timer to send a “zone enabled (24) mode and then to Timer Expired? (26) condition. If yes, then input is routed back to (D). If no, then input is routed back to (24).

If CASE Zone Disable (16) condition is no, then control system input is routed to CASE Zone Enabled (28) condition. If yes, then input is routed to Set “zone mode” To Enabled (30) mode and then routed to Velocity Bad? (32) condition. If no, then input is routed to Enable Transmission and Reception (34) mode. If CASE Zone Enabled (28) condition is no, then input is routed to CASE Velocity (36) condition. If yes, then input routes to Greater than Preset? (38) condition. If no, then input routes to Set Velocity Good (40) mode and on to “zone mode” disabled? (42) condition. If no, then input routes to Enable Transmission and Reception (46) mode.

If Greater than Preset? (38) is yes, then control system input routes to Set Velocity Bad (44) mode and on to “main mode” emergency? (48) condition. If no, then input is routed to Disable Transmission and Reception (50) mode.

It is useful to note that in the Flow Chart FIG. 2; END select (52) is used as a termination point of control system input. When Enable Transmission and Reception mode and Disable Transmission and Reception mode have concluded, control system input routes to END select mode. Control system input is also routed to END select mode if some “yes” or “no” input conditions warrant.

### DESCRIPTION AND OPERATION OF ALTERNATIVE EMBODIMENTS

The invention may be embodied as an E.P.R.O.M. or as an integrated circuit. The invention may be embodied using a series of transistors, as an integrated circuit or several integrated circuits or a combination of these in conjunction with or without software components. In all of these cases, the operation of the invention would be essentially the same as that of a software embodiment and thereby realizing the same logic based control system as is constituted by a software embodiment of this invention.

### ADVANTAGES

The preferred embodiment has an advantage that little manufacturing may be required to produce the invention. Software occupies no physical space; therefore no physical modification of wireless communication devices may be needed.

### CONCLUSION, RAMIFICATIONS, AND SCOPE OF INVENTION

The reader can see that the invention titled “Location and Velocity Related Control System for Wireless Communication Devices”, as described herein, automatically and continuously exerts control over the operation of portable and other wireless communication devices equipped with this control system, when those devices are located within a moving environment such as a moving automobile or moving aircraft thereby increasing the safety of these and associated environments.

Independent of a wireless communication device's user, the invention is able to automatically modify the utility of portable and other wireless communication devices, when those devices are located within an environment where the operation of such devices may be disruptive, unwanted, or contrary to other activities conducted in an environment such as theaters, restaurants or private meeting places.

For wireless communication devices equipped with this control system, the invention provides to continually enable access to emergency communications in any environment or time. The invention is accomplished through software to modify the operating systems of wireless communication devices.

The invention may be best accomplished through software added to modify the operating systems of wireless communication devices. The preferred embodiment of the invention is expressed herein in “pseudo code”.

While the above description contains many specificities, these should in no way be construed as limitations on the scope of the invention, but rather an exemplification of one preferred embodiment thereof. Many other variations are possible. For example, other programming languages and codes can be used to accomplish the same invention. PROM, E.P.R.O.M.S, integrated circuits, combinations of transistors and combinations thereof with or without software components can also be used to this end. Accordingly, the scope of the invention should be determined not by the embodiments illustrated, but by the appended claims and their legal equivalents.

### SEQUENCE LISTING

Not Applicable

I claim:

1. A location and velocity related control system for wireless communication devices comprising:
a control system input responsive to an event or condition associated with a defined velocity and for providing information describing that event or condition.
a control system input responsive to an event or condition associated with a defined time period and for providing information describing that event or condition
a control system input responsive to an event or condition associated with a defined geographical location and for providing information describing that event or condition.
a plurality of sensor means operatively connected with said control system input unit for detecting an event or condition associated with the wireless communications device.
a satellite receiver responsive to navigation signals transmitted by a satellite navigation system and/or other wireless communications systems for providing information inherently describing the wireless communication device's location, time and/or velocity based on the navigation signals.
a wireless communication device control system operatively connected with and responsive to said satellite receiver and/or other wireless communication systems wherein said wireless communication transmitter is for transmitting information onto a communications link, the information transmitted including both the information describing an event or condition and information describing the wireless communications device's location, time and/or velocity wherein said control system provides user interface via the said wireless communication device control system with an uninterrupted or direct link for emergency communication access.

2. A control system for wireless communication devices according to claim 1,
wherein said communications link is an analog cellular telephone link.

3. A control system for wireless communication devices according to claim 1, wherein said communication link is a digital cellular link.

4. A control system for wireless communication devices according to claim 1, wherein said sensor means comprise mechanical, electrical or magnetic means.

5. A control system for wireless communication devices according to claim 1, wherein said sensor means detects events or conditions selected from the group consisting of velocity conditions, real time conditions, timed event conditions, geographic location and conditions and geographic proximity conditions.

6. A control system for wireless communication devices according to claim 1, wherein said sensor means activate, deactivate or override the wireless device upon detection of an event or condition associated with the wireless communications device.

7. A control system for wireless communication devices according to claim 1, comprising of a plurality of visual and/or audio indicating means to alert an occupant or operator of the wireless communication device of sensor activation or activity.

8. A control system for wireless communication devices according to claim 1 wherein said visual indicating means include an “out of service” yellow light emitting diode, an “activated” yellow and/or green light emitting diode, an “override” yellow light emitting diode, an “de-activate” yellow light emitting diode, and an “emergency” red light emitting diode.

9. A control system for wireless communication devices according to claim 1, wherein said visual indicating means include text messaging, icons or graphic display.

10. A control system for wireless communication devices according to claim 1, further comprising means that enable an occupant or operator of the wireless communication device to immediately establish two-way communication with said emergency communication and/or dispatch facilities.

11. A control system for wireless communication devices according to claim 1, further comprising a means of communication of status of conditions or events to incoming communications attempted while said wireless communication controller unit system is in “disable” mode.

12. A control system for wireless communication devices according to claim 1, wherein said wireless communication controller unit system is battery powered.

13. A control system for wireless communication devices according to claim 1, wherein an override device enables the wireless communication device controller unit to be enabled, disabled or overridden by way of wireless communication between the two devices.

14. A control system for wireless communication devices according to claim 1, wherein said override device includes at least one command button.

15. A control system for wireless communication devices according to claim 1, wherein said override device is capable of emitting a signal selected from the group consisting of a radio frequency signal, and infrared signal and an ultrasonic signal.

16. A control system for wireless communication devices according to claim 1, wherein said wireless communication device is capable of receiving a signal from said override device selected from the group consisting of a radio frequency signal, and infrared signal and an ultrasonic signal.
